(19) United States
(12) Patent Application Publication
(10) Pub. No.: US 2013/0041797 A1
(43) Pub. Date: Feb. 14, 2013

(54) BANKING LOCATION UTILIZING SECURE TRANSACTION STATION AND METHOD OF PROCESSING CONSUMER BANKING TRANSACTIONS

(71) Applicants: James W. Geeslin, Lorena, TX (US); Misti J. Mostiller, Waco, TX (US); Holly D. Gamrod, West Point, TX (US); Sandra L. Dixon, Temple, TX (US); Cheryl L. Gochis, Woodway, TX (US)

(72) Inventors: James W. Geeslin, Lorena, TX (US); Misti J. Mostiller, Waco, TX (US); Holly D. Gamrod, West Point, TX (US); Sandra L. Dixon, Temple, TX (US); Cheryl L. Gochis, Woodway, TX (US)

(21) Appl. No.: 13/349,215

(22) Filed: Jan. 12, 2012

Related U.S. Application Data
(60) Provisional application No. 61/432,186, filed on Jan. 12, 2011.

(51) Int. Cl. G06Q 40/02

(52) U.S. Cl. 705/35

(57) ABSTRACT

A banking location having one or more transaction stations each with a secure automated cash recycler for receiving and dispensing money for customer deposits and withdrawals. The banking location may further include a remote assistance station for connecting a customer with a complicated transaction with a banking associate from a remote location who may complete the customer transaction without disrupting the customer transaction flow of the banking branch.

### CROSS-REFERENCE TO RELATED APPLICATIONS

This application claims the benefit of U.S. Provisional Application No. 61/432,186, filed Jan. 12, 2011, which is hereby incorporated by reference as though fully set forth herein.

### BACKGROUND OF THE INVENTION

a. Field of the Invention

The present disclosure relates to the efficient processing of retail bank branch consumer transactions. In particular, the present disclosure relates to the use of distributed cash transaction stations and remote assistance stations to achieve greater efficiency in processing banking transactions.

b. Background Art

It is well known that traditional retail banking branches commonly consist of general lobby area separated from a cashier or teller cage area by a teller counter having one of a variety of physical security measured generally designed to prevent theft and protect tellers. Examples of such physical security measures include bars extending upwards from the teller counter and translucent acrylic enclosures extending from the counter to the ceiling. These physical security measures deter theft and protect tellers, yet serve to isolate banking representatives from customers. In some acrylic enclosure arrangements verbal communication is largely obstructed by the solid dividers, and must be accomplished through the use of an intercom system. Such security arrangements reduce consumer banking transactions to a very impersonal nature, and make it difficult for banking associates to interact with consumers or identify consumer needs.

Traditional teller counters can also lead to lengthy lines of consumers attempting to make routine transactions such as small deposits or withdrawals, when one or more of the available tellers are servicing a consumer having a complicated or long duration transaction. Loss of one teller for an extended period can quickly cause a line to form leading to inefficiencies and unhappy customers. Further, tellers are limited to handling transactions not requiring a private setting, such as loan originations, because the teller may not easily leave the secured cage area. Because tellers cannot leave the cage area bank branches required to maintain separate staffing for handling more complicated transactions requiring a measure of privacy.

The inventors herein have thus recognized a need for a banking branch and method for processing customer transactions allowing banking employees to freely interact with customers to increase customer satisfaction and transaction processing efficiencies.

### BRIEF SUMMARY OF THE INVENTION

It is desirable to be able to provide a banking environment having a plurality of transaction stations dispersed within a banking lobby. Each transaction station may contain a computer system for use by a banking associates and a cash recycler for receiving and dispensing cash in response to input received by the computer from the banking associates. The cash recycler maintains all cash in a secure storage compartment allowing the banking associate to quickly move from the transaction station to assist customers in other locations within the bank branch. It is further desirable to provide a remote assistance station within the banking environment configured to allow a banking associate from a remote location to process customer transactions using a video teleconference connection. The remote assistance station may further be used to increase banking transaction throughput by servicing complicated or otherwise length transactions, leaving more transaction stations free to process routine deposits and withdrawals.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 generally illustrates a transaction station configured to allow secure processing of customer transactions at any location within a banking branch.

FIG. 2 generally illustrates a cash recycler positioned within a transaction station.

FIG. 3 generally illustrates an informational tower configured in accordance with the present disclosure.

FIG. 4 generally illustrates a remote assistance station in accordance with the present disclosure.

FIG. 5 further illustrates the personal interaction provided by the display window of the remote assistance station.

FIG. 6 is a flow chart illustrating a customer transaction and how a banking associate and remote banking associate coordinate processing.

FIG. 7 generally illustrates a lobby coin counter for reducing long duration customer transactions in accordance with the present invention.

### DETAILED DESCRIPTION OF THE INVENTION

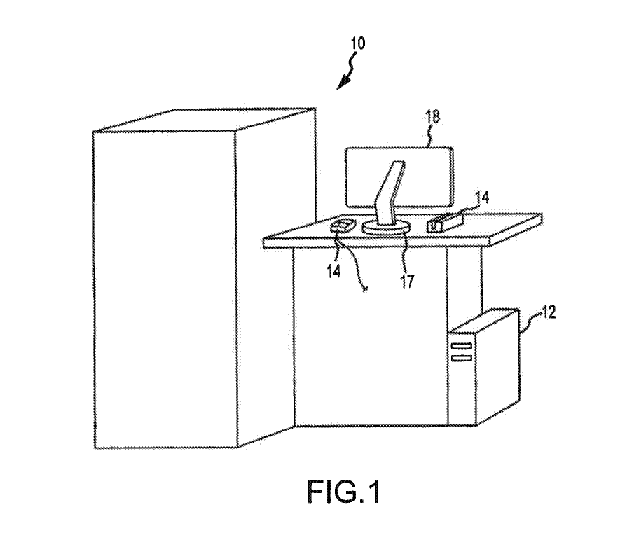

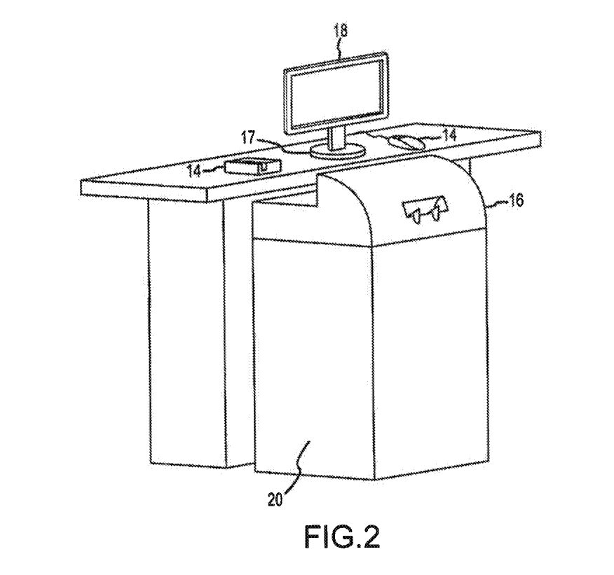

Referring now to the drawings wherein like reference numerals are used to identify identical components in the various views, FIG. 1 illustrates a transaction station 10 for use by a banking associate for processing customer transactions. The transaction station 10 allows for the secure processing of all customer transactions by the banking associate by maintaining automated control over the cash received from customers and cash for customer withdrawals. The transaction station 10 can be configured with a computer workstation 12 having one or more input devices 14 for receiving input from the banking associate and for processing customer transaction paperwork, such as, by way of example, deposit slips and checks. Input devices 14 include computer mice, keyboards, and number pads as well as digital scanners for receiving customer paperwork. The computer 12 may be programmed with software allowing the banking associate to access customer accounts and to operate one or more peripheral devices, such as a scanner, printer, or a cash recycler 16 (shown in FIG. 2). The transaction station 10 may further include a swivel counter top section 17 on which a monitor 18 connected to the computer 12 is placed, allowing the banking associate to freely rotate the monitor 18 to display information to the customer and thereby facilitating a more personal interaction between the customer and the banking associate regarding account information or available banking features.

The transaction station 10 further includes a cash recycler 16 for securely processing cash transactions, maintaining a secure cash repository, and for automating cash balancing operations. As shown in FIG. 2, the cash recycler 16 is operably connected to the computer 12 and dispenses cash for customer withdrawals and receives cash from customer deposits in response to input received by the computer 12 from the banking associate. The cash recycler 16 automatically counts out bill denominations for cash deposits and cash withdrawals faster than a human teller, thereby shortening the time consumed with each transactions. Further, the automated nature of the counting allows the banking associate to engage the customer in conversation and identify additional banking services or account features that the customer may find beneficial while the deposit or withdrawal is being counted.

The cash recycler 16 is configured to maintain all cash in a secured compartment 20 that is not physically accessible to customers or banking associates, thereby reducing opportunities for both employee embezzlement and/or theft. Traditional teller cash drawers require each teller to maintain their own cash drawer for transactions, located at a specific teller window. Each teller would also necessarily be required to count and balance their cash drawer. The cash recycler 16 automates all balancing computations, relieving banking associates of the time consuming counting and balancing labor. Because the cash recycler 16 handles balancing calculations, banking associates are not linked to a given station or cash drawer, as with prior teller arrangements, allowing the banking associates to work at any available transaction station 10.

The cash recycler 16 may further be configured to use cash received from customer deposits to resupply its available cash for withdrawals, and in this manner, substantially reduce the number of cash transfers to and from the cash vault of the bank branch, thereby reducing the amount of cash needed in the bank branch vault. The cash recycler 16 further reduces the required cash in the branch vault because cash drawers, which would be placed in the vault when not in use, are eliminated by the cash recycler 16. Use of a cash recycler 16 further reduces administrative burdens by eliminating surprise audits routinely performed on banking associate cash drawers.

The increased security of the cash recycler 16 provides other substantial benefits, the first of which is eliminating the need for banking transactions to be processed from a secured environment, which traditionally required customers to interact with banking associates through one or more security features. Traditional security features include bars and bullet proof glass enclosures, both of which necessarily create a physical separation between the banking associates and the customer. Certain security feature configurations further impede customer transactions, such as when the physical barrier blocks or obscures verbal communication. The present disclosure eliminates these physical barriers through the use of the cash recycler 16 to maintain the physical security, thereby allowing the banking associate to interact with the customer on a much more personal level. Use of the cash recycler 16 within the transaction station 10 allows the transaction station 10 to be located at any point within the banking branch, rather than in a centralized location behind traditional security barriers.

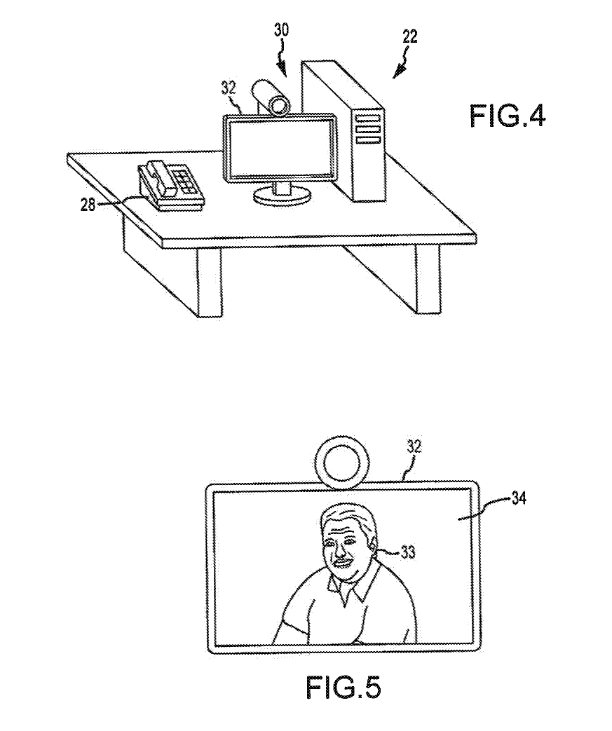

In addition to individual transactions being completed in a more personal manner, the cash recycler 16 allows the banking associate freedom to step away from the transaction station 10 without the need to lock or secure any cash drawer. Thus, banking associates can move to personally greet customers upon their entrance to the banking branch, assist customers in locating or completing any required forms, as well as escort customers to a particular location, such as, by way of example, a remote assistance station 22, shown in FIG. 4 and described in detail below. The ability to move freely throughout the bank space further allows banking associates to perform roles beyond deposit and withdrawal transactions, such as loan origination, because banking associates may accompany customers to an office, cubicle, or other private area for completion of the required paperwork. In this manner, the traditional role of the teller is eliminated.

When an existing banking branch is renovated to include transaction stations 10, the traditional teller window counter may be reconfigured to contain a doorway, swinging gate, or other access point allowing employees to move from the behind the counter to assist and interact with customers without leaving sight of the customer, which is impossible with traditional teller counter designs. The added mobility increases personal interaction with the customer and allows banking associates to escort those customers needing special assistance to the appropriate station within the branch. Newly constructed banking branches require less square feet to handle the same customer volume because the secured teller area required in prior designs may be replaced by a series of transaction stations 10 within the branch lobby itself. For complicated or long duration transactions, the banking branch may optionally include a remote assistance station 22.

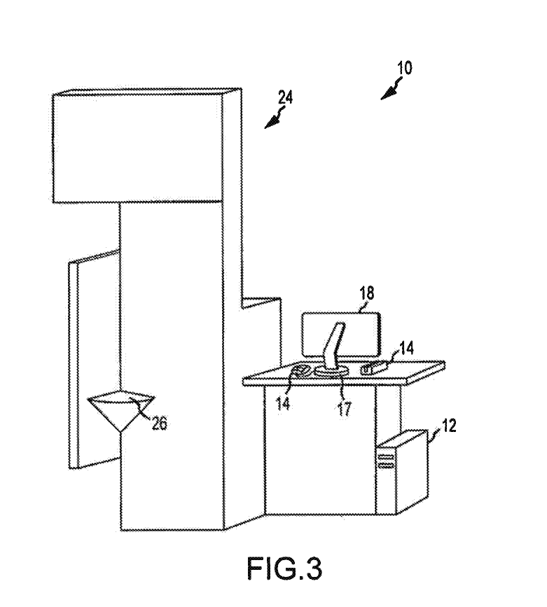

As shown generally in FIG. 3, transaction stations 10 may also include an informational tower 24 extending above the transaction station 10 to display information to customers, such as available services, new product promotions, or other customer targeted information. In one embodiment, the information tower 24 may be located in close proximity to a transaction station 10 and be configured with a writing surface 26 for customers to complete banking forms on the information tower, thereby encouraging customers to interact and be exposed to the displayed information.

As depicted in FIG. 4, the remote assistance station 22 may have a phone 28, a computer 30, a monitor with integrated camera 32, and a printer (not shown). The computer 30 may be configured to contain an executable application program or other logic enabling a video conference between the customer and a remote banking associate 33. As shown in FIG. 5, the program may be configured to generate a display window 34 that is communicated to and depicted upon the monitor 32, the display window 34 containing a substantially live picture of the remote banking associate 33 received from a camera located at the remote banking associate's 33 location, and optionally, a substantially live picture of the customer from the camera of the remote assistance station 22. The picture from the camera of the remote assistance station 22 may be depicted on the remote banking associate's 33 monitor, thereby simulating a face-to-face conversation.

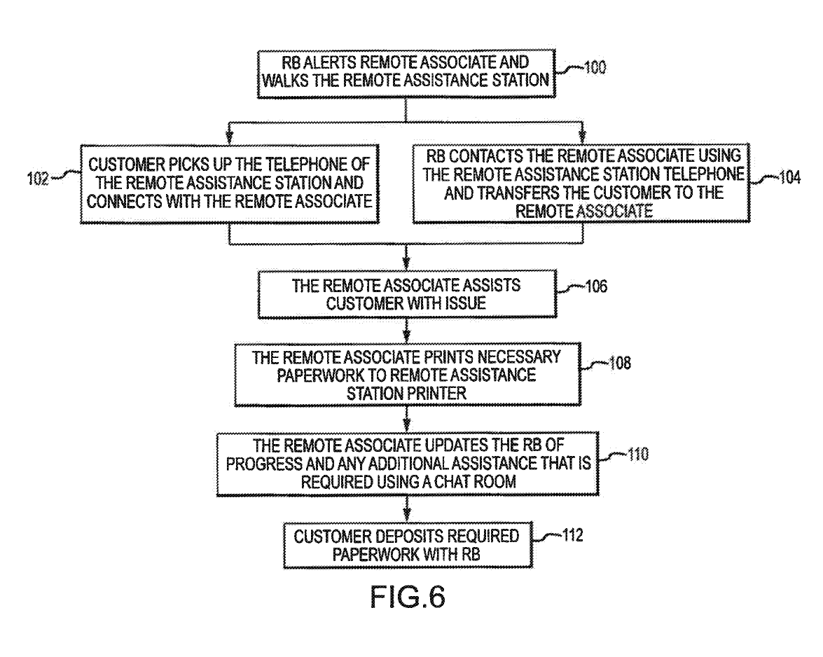

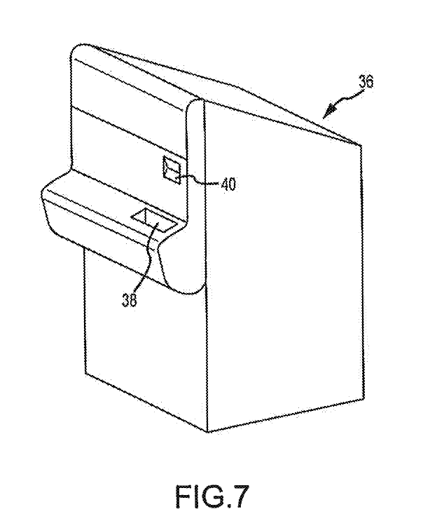

In one embodiment depicted in the flow chart of FIG. 6, the step of initiating a video conference 100 using the remote assistance station 22 may be performed by the banking associate (shown as RB), who may direct the customer to the phone 28, as in step 102, or the banking associate may affirmatively establish a connection with the remote associate 33 before transferring the phone 28 to the customer, as in step 104, after which the remote associate assists the customer (step 106). In an alternative embodiment, the phone 28 may be configured to automatically establish a connection with a remote banking representative 33 by establishing a connection with a remote customer service server which supplies an address for a network connection to an available remote banking associate 33. In an alternative embodiment, some portion or all of the video conference information may be routed through a telephone network. The printer is operably connected through a data network to the remote banking associate 33 and thereby allows the remote banking associate 33 to print forms required to complete the customer transaction, as in step 108.

The computer 30 is further configured to maintain an associate chat room containing a registry of all banking associates related to the customer transaction. The associate chat room can be configured to allow communication between the remote banking associate 33 and banking associates present within the banking branch with the customer enabling the banking associates to remain informed of the progress of the transaction, as in step 110. Communication between the remote associate 33 and the associates of the branch allow the branch associates to quickly provide any additional assistance the customer requires, such as collecting any completed forms, as in step 112. In one embodiment of the present disclosure, communication between the remote banking associate 33 and banking associates present at the branch may take the form of a text based web chat. A text based communication medium, such as a web chat room or instant web messaging allow the remote banking associate 33 to communicate verbally with the customer while communicating in parallel with the other banking associates using the associate chat room.

The remote banking associate 33 can be a dedicated employee at a centralized location, such as a call center, whose primary responsibility is to handle customer transactions from the remote assistance station 22. Alternatively, calls from the remote assistance station 22 may be routed to remote banking associates 33 handling other customer service calls. However, calls routed to remote banking associates 33 handling other types of customer calls may result in the customer using the remote assistance station to have to wait, as all associates 33 may be busy on other calls when the remote assistance station call is originated. In another embodiment of the invention, calls from the remote assistance station are routed to banking associates 33 handling text based customer inquiries, such as, by way of example, website chat support or email queries. Because banking associates 33 responding to text based queries are not already involved in a voice conversation with a customer, these banking associates 33 may immediately answer a call from the remote assistance station 22, thereby rewarding the customer who has taken the time to come to a branch office with immediate service, just as they would receive from branch banking associates.

The remote assistance station 22 allows a bank branch to maintain a higher customer transaction throughput, and thereby minimize the time a customer waits for service, in two ways. First, the a customer may elect to use the remote assistance station 22 rather than wait for a banking associate within the branch to become free. In this case, the customer receives immediate service regardless of the type of transaction the customer desires. Second, the remote assistance station 22 may be used to handle long duration transactions, which are transactions that may require a banking associate with specialized training or review by a banking administrator to complete. When a banking associate from the branch handles a long duration transaction that employee and transaction station 10 are not available to service customers with more routine transactions, effectively reducing the throughput of routine transactions, which may lead to lines and customer dissatisfaction with wait times. By diverting long duration transactions to the remote assistance station 22 the branch banking associates may maintain a higher processing rate for routine transactions, while maintaining immediate face-to-face service. This allows bank branches to provide a higher service level to customers without maintaining extra staffing to address occasional long duration transactions. Similar efficiencies may be accomplished through the use of a lobby coin counter station 36, an example of which is generally depicted in FIG. 7. The lobby coin counter 36 may be a free standing kiosk or machine having a coin receptacle 38 and a printer 40. The lobby coin counter 36 receives coinage from the customer in the coin receptacle 38, the lobby coin counter 36 then sorts the coins and calculates a deposit value. The deposit value is then printed on a receipt by the printer 40 and the receipt is issued to the customer. The customer may redeem or deposit within an account the deposit value shown on the receipt at a transaction station 10. By automating the coin counting and valuation functions, the lobby coin counter 36 reduces a potentially long duration transaction into a routine one that does not disrupt general customer transaction processing flow rates.

Although several embodiments of this invention have been described above with a certain degree of particularity, those skilled in the art could make numerous alterations to the disclosed embodiments without departing from the spirit or scope of this disclosure. For example, variations in the described hardware components or banking branch components are possible without deviating from the spirit of the disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A retail banking location comprising:
a plurality of transaction stations having a cash recycler and a computer, the computer being configured to receive input from a user, the cash recycler having a secure compartment containing a plurality of monetary bills, the cash recycler being configured to receive or dispense a monetary bill in response to user input and maintain a cash balance of the monetary bills in the secure compartment, the plurality of transaction stations being located in a banking lobby freely accessible to a banking customer.

2. The retail banking location of claim 1, each of the plurality of transaction stations having a scanner, the scanner being configured to read a customer transaction record and communicate a transaction request to the computer, the computer being configured to receive transaction requests and to instruct the cash recycler to execute the transaction request.

3. The retail banking location of claim 2 wherein the cash recycler executes the transaction request by dispensing a monetary bill and debits the cash balance.

4. The retail banking location of claim 2 wherein the cash recycler executes the transaction request by receiving a monetary bill and crediting the cash balance.

5. The retail banking location of claim 2 wherein the customer transaction record is a deposit slip.

6. The retail banking location of claim 2 wherein the customer transaction record is a withdrawal slip.

7. The retail banking location of claim 2 wherein the customer transaction record is an endorsed check.

8. The retail banking location of claim 1 further comprising a automatic coin counter, the automatic coin counter being configured to receive one or more monetary coins, determine the value of the received monetary coins, and generate a customer transaction record including the value of the received monetary coins.

9. The retail banking location of claim 1 further comprising a remote assistance station comprising a user computer operably connected to a display device and one or more user input devices, the user computer being operably connected to a remote computer, the remote computer being configured to communicate a video image of a remote computer operator to the user computer, the user computer being configured to receive the video image and display the video image on the display device.

10. The retail banking location of claim 9 further comprising a automatic coin counter, the automatic coin counter being configured to receive one or more monetary coins, determine the value of the received monetary coins, and generate a customer transaction record including the value of the received monetary coins.

11. The retail banking location of claim 9, the remote assistance station further comprising a printer being operably connected to the remote computer, wherein printer can receive printing instructions from the remote computer.

12. The retail banking location of claim 9 wherein the remote assistance station is further configured to maintain a text based communication interface capable of receiving text communication from one of the computer of a transaction station or the remote computer and routing the received text communication to the other of the computer of the transaction station or the remote computer for display.

13. A banking station comprising:
a cash recycler, a computer, a display device, a scanner, and a housing, the housing containing the cash recycler and the computer, the housing having a work surface supporting the display device, the scanner and one or more user input devices operably connected to the computer, the computer being operably connected to the cash recycler and an account server, the computer being configured to access customer account information from the account server, the cash recycler having storage compartment, a cash dispenser, and a cash receptacle, the cash recycler being configured to dispense or receive a monetary bill in response to input received from the computer, the cash recycler being further configured to maintain a cash balance of all monetary bills dispensed or received.

14. The banking station of claim 13 wherein the scanner is configured to read a customer transaction record and communicate a transaction request to the computer, the computer being configured to receive transaction requests and to instruct the cash recycler to execute the transaction request.

15. The banking station of claim 14 wherein the computer is further configured to communicate the transaction request to the account server and receive an acknowledgment from the account server prior to instructing the cash recycler to execute the transaction request.

16. The banking station of claim 14 wherein the cash recycler executes the transaction request by dispensing a monetary bill and debits the cash balance.

17. The banking station of claim 16 wherein the cash recycler further executes the transaction by communicating a completion acknowledgment to the computer.

18. The banking station of claim 14 wherein the cash recycler executes the transaction request by receiving a monetary bill and crediting the cash balance.

19. The banking station of claim 18 wherein the cash recycler further executes the transaction by communicating a completion acknowledgment to the computer.
